(19) United States
(12) Patent Application Publication
(10) Pub. No.: US 2014/0061221 A1
(43) Pub. Date: Mar. 6, 2014

(54) VENDING MACHINE WITH TEMPERATURE CONTROL SYSTEM

(71) Applicant: HON HAI PRECISION INDUSTRY CO., LTD., New Taipei (TW)

(72) Inventors: CHIH-HANG CHAO, New Taipei (TW); WEI-CHENG CHENG, New Taipei (TW)

(73) Assignee: HON HAI PRECISION INDUSTRY CO., LTD., New Taipei (TW)

(21) Appl. No.: 13/887,833

(22) Filed: May 6, 2013

(30) Foreign Application Priority Data
Aug. 29, 2012 (CN) 2012103119333

(51) Int. Cl. G07F 9/10

(52) U.S. Cl. CPC G07F 9/105
USPC 221/150 R

(57) ABSTRACT

A vending machine includes a rack, and a temperature control system. The rack includes a rear plate. The temperature control system is secured to the rack and includes an evaporator. The evaporator includes an installation box, a plurality of fins, and a fan. The plurality of fins is secured to the installation box. The fan is secured to the installation box and inclined to the plurality of fins, and an acute angle is defined between an air outlet of fan and the rear plate.

### BACKGROUND

1. Technical Field

The present disclosure relates to vending machines, and more particularly to a vending machine with a temperature control system.

2. Description of Related Art

Vending machine includes a plurality of trays. The plurality of trays are secured in parallel to a rear plate, for receiving an amount of merchandise, such as water, tissues or assorted snacks, twenty four hours a day. A temperature control module is used in the vending machine to control temperature of goods, to prevent the goods from going bad. Generally, the temperature control module includes an evaporator, a compressor, and a condenser. The evaporator may include an installation box, a plurality of fins, and a fan. The compressor and the condenser guide airflow to the plurality of fins. The fan pumps airflow to the vending machine from the plurality of fins and secured to the installation box. The air outlet of the fan is aligned with the plurality of trays; airflow may be backflow when the airflow meets the plurality of trays, which may affect the guiding airflow efficiency of the fan. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a vending machine in accordance with an embodiment.

FIG. 2 is an exploded view of a temperature control system of FIG. 1.

FIG. 3 is an exploded view of an evaporator of FIG. 2.

FIG. 4 is an assembled view of the vending machine of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

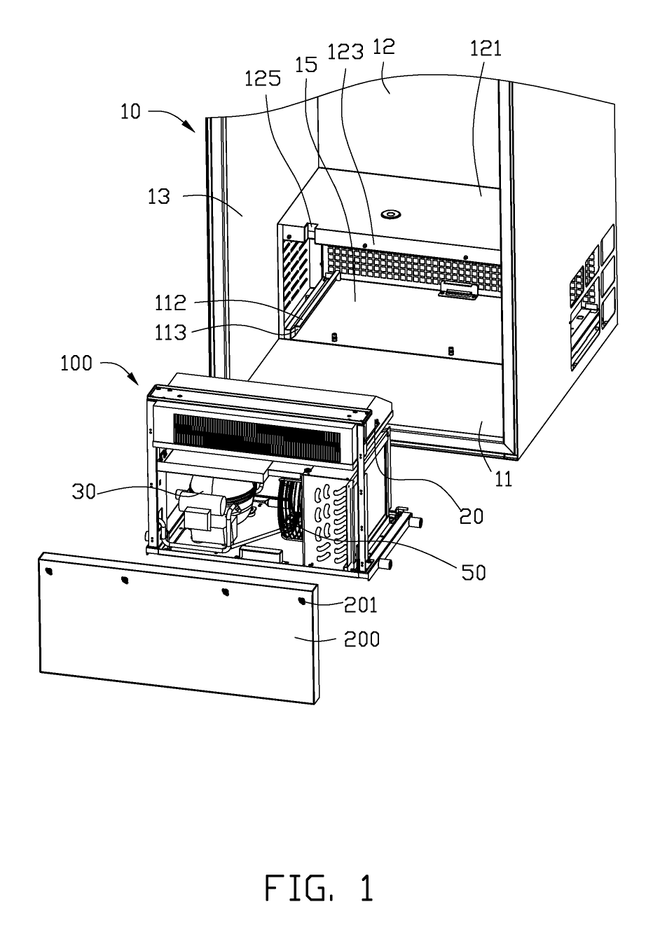

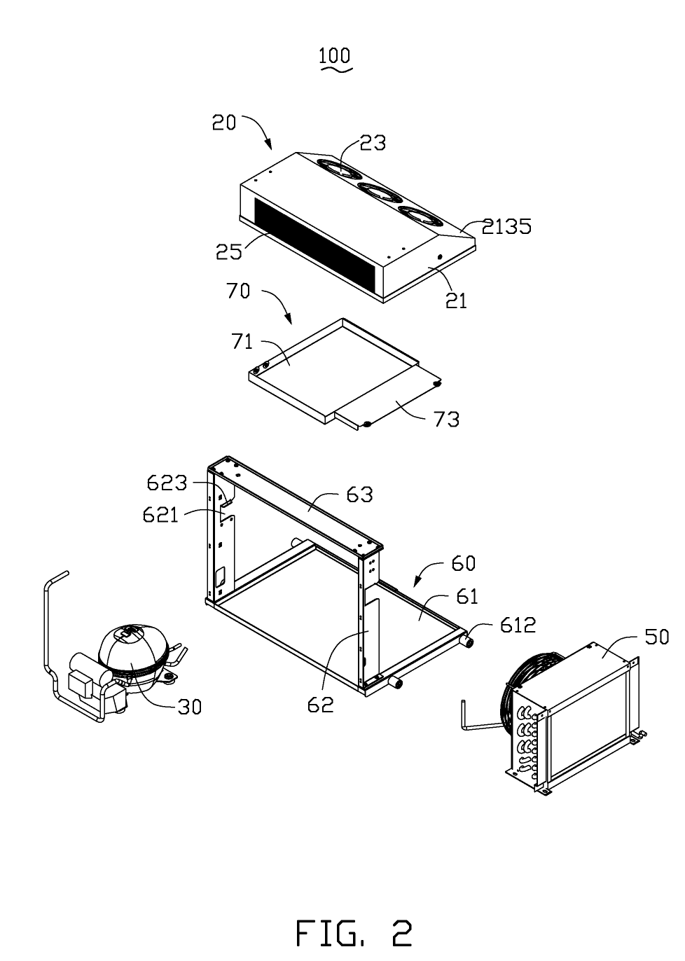

FIGS. 1-2 illustrate a vending machine in accordance with an embodiment. The vending machine includes a rack 10 (only a part of the rack 10 is shown in FIG. 1), a temperature control module 100, and a warming module 200.

The rack 10 includes a bottom plate 11, a rear plate 12, and two side plates 13. In one embodiment, the bottom plate 11 is substantially perpendicular to the rear plate 12 and the two side plates 13. The rear plate 12 is substantially perpendicular to the two side plates 13. A plurality of trays (not shown) are located on the rear plate 12, for receiving a canned product, or a plastic-bottled product, like a beverage such as water, for example.

The rack 10 further includes two sliding rails 112 each adjacent to each of the two side plates 13. Each sliding rail 112 and the bottom plate 11 defines, near by a sliding channel 113 for receiving the temperature control module 100.

A securing plate 121 extends substantially perpendicularly from the rear plate 12. The securing plate 121 is substantially parallel to the bottom plate 11 and includes a mounting flange 123. The mounting flange 123 is away from the rear plate 12 and substantially parallel to the rear plate 12. The securing plate 121 defines a receiving slot 125 towards the rear plate 12 and a plurality of mounting holes 1231 for securing the keeping warming module 200. A receiving space 15 is defined cooperatively by the securing plate 121, the bottom plate 11 and the two side plates 13 for receiving the temperature control module 100. A blocking member 17 is secured to the bottom plate 11 and adjacent to the rear plate 12. The blocking member 17 includes two blocking pieces 171 each being substantially parallel to the bottom plate 11.

FIG. 2 shows that an evaporator 20, a compressor 30, a condenser 50, a bracket 60, and a dividing member 70 are included in the temperature control module 100. The evaporator 20 includes an installation box 21, three fans 23, and a plurality of fins 25.

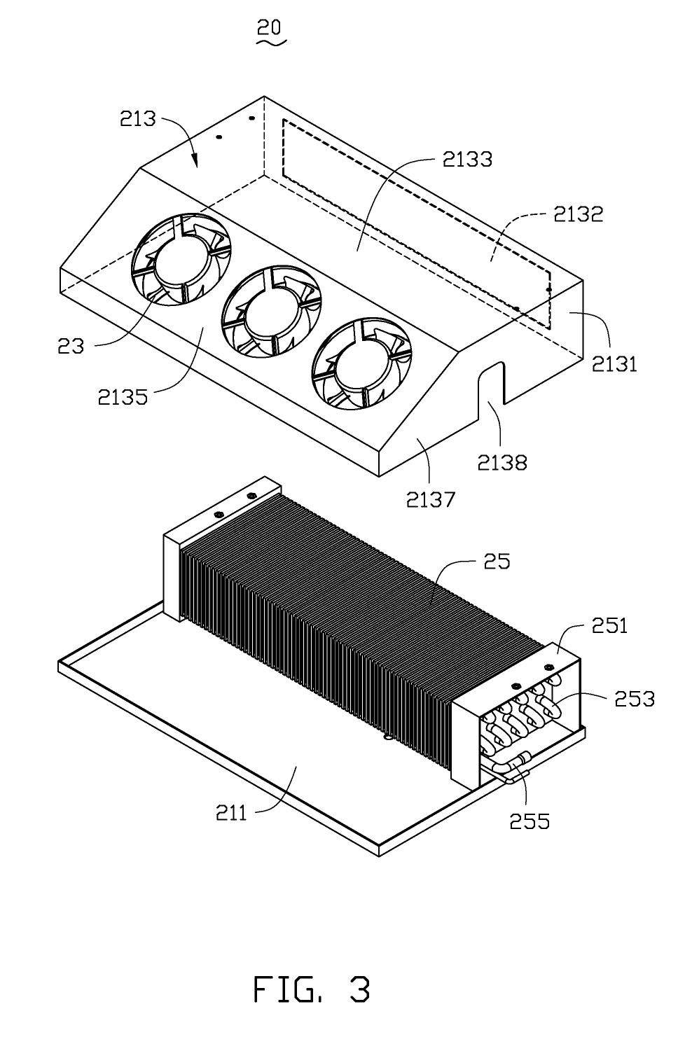

FIG. 3 shows that the installation box 21 includes a cover 213 and a supporting tray 211 secured to the cover 213 for closing the cover 213. The cover 213 includes a rear wall 2131, a front wall 2135, a top wall 2133, and two sidewalls 2137. The rear wall 2131 and the front wall 2135 are located on opposite sides of the top wall 2133. The two sidewalls 2137 are located on other sides of the top wall 2133, connecting the rear wall 2131 and the front wall 2135, respectively. The rear wall 2131 defines an air vent 2132 and is substantially perpendicular to the top wall 2133. An obtuse angle is defined between the front wall 2135 and the top wall 2133, and an acute angle is defined between a first plane with the front wall 2135 and a second plane with the rear wall 2131. The three fans 23 are secured to front wall 2135 and are slanted to the rear wall 2131. One of the two sidewalls 2137 defines a gap 2138 for the compressor 30 communicating with the plurality of fins 25.

The plurality of fins 25, parallel to each other, are secured to the top wall 2133 via two clamping structures 251. One side of the plurality of fins 25 abuts the rear wall 2131, and another side of plurality of fins 25 is adjacent to the three fans 23. An airflow guiding passage is formed between adjacent two of the plurality of fins 25 and communication with the air vent 2132. A heat pipe 253 is engaged in the plurality of fins 25, and a transfer pipe 255 connects the heat pipe 253 to the compressor 30.

FIG. 2 shows that, the bracket 60 include a base 61, two support plates 62 secured to the base 61, and a pulling plate 63 secured to the two support plates 62. Two sliding posts 612 are secured to each of opposite sides of the base 61. Each support plate 62 defines a cutout 621. A maintaining piece 623 extends from a top edge of the cutout 621. In one embodiment, the pulling plate 63 is substantially parallel to the base 61, each of the two support plates 62 is substantially perpendicular to the base 61 and the pulling plate 63, and the maintaining piece 623 is substantially parallel to the base 61. A distance between the two blocking pieces 171 is substantially equal to a height of the base 61. A width of the receiving slot 125 is substantially equal to a width of each support 62.

The dividing member 70 includes a dividing plate 71 and an installation plate 73 extending from a side of the dividing plate 71.

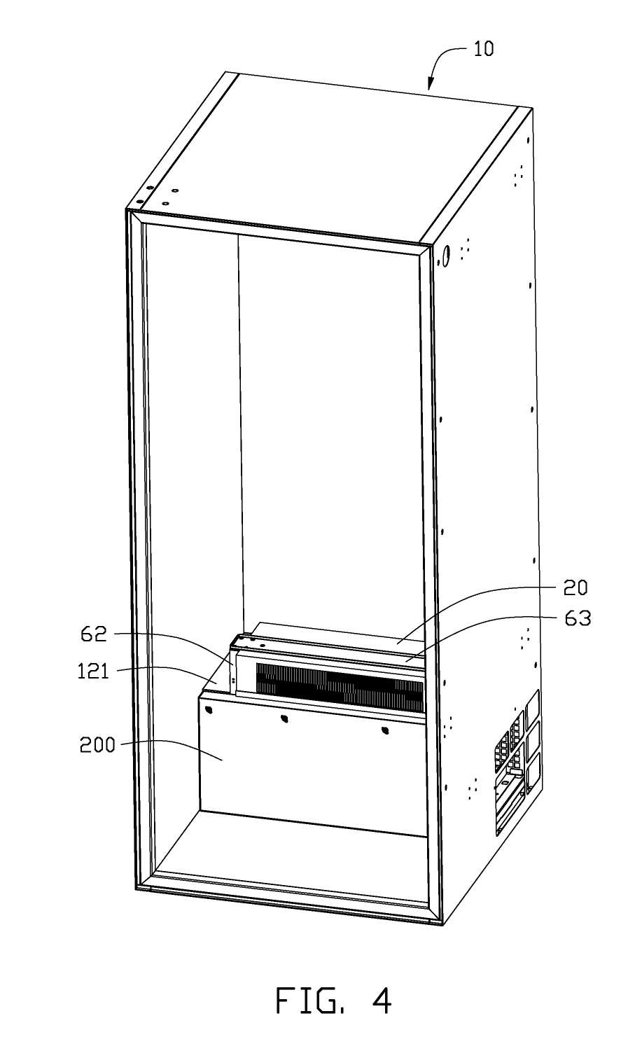

FIGS. 4 shows that in assembly of the temperature control module 100, the compressor 30 and the condenser 50 are secured to the base 61. The dividing plate 71 is secured to one of the two support plates 62. The installation plate 73 is secured to the condenser 50. The evaporator 20 is placed on and is secured to the maintaining pieces 623 of the two support plates 62. The dividing member 70 separates the evaporator 20 from the compressor 30 and the condenser 50. A distance between the dividing member 70 and a bottom surface of the evaporator 20 is substantially equal to a height of the securing plate 121.

In assembly of the temperature control module 100 to the rack 10, the temperature control module 100 is placed in the rack 10 and the sliding posts 612 is aligned with the sliding channel 113. The temperature control module 100 is pushed to slide the sliding posts 612 along the sliding channel 113, until received in the receiving space 15. In this position, a part of each support 62 is received in the receiving slot 125, the evaporator 20 above the securing plate 121, and an acute angle is defined between the front wall 2135 of the evaporator 20 and the rear plate 12. The keeping warm module 200 is moved to be adjacent to the temperature control module 100 and secured to the securing plate 121 via a plurality of locking members 201, for covering the receiving space 15.

In use, the compressor 30 and the condenser 50 generates cool water and transfers the cool water to the heat pipe 253 via the transfer pipe 255. The plurality of fins 25 generate cooling airflow and guide airflow to the rack 10 through the air vent. The three fans 23 guide airflow from the plurality of the fins 25 to the rear plate 12, then to the plurality of trays. An acute angle is defined between air outlet of each fan 23 and the rear plate 12, for preventing the airflow from back flowing, to increase a guiding airflow efficiency of the fans 23.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A vending machine comprising:
a rack, the rack comprising a rear plate; and
a temperature control system, secured to the rack, comprising an evaporator; the evaporator comprising an installation box, a plurality of fins, and a fan; and the plurality of fins is secured to the installation box, the fan is secured to the installation box;
wherein an acute angle is defined between an air outlet of the fan and the rear plate.

2. The vending machine of claim 1, wherein the installation box comprises a cover, the cover comprises a front wall, a rear wall, and a top wall connecting the front wall to the rear wall; the fan is secured to the front wall, the plurality of fins are secured to the top wall and adjacent to the rear wall; and the fan guides airflow to the rack through the air outlet, and the plurality of fins guides airflow to the rack through an air vent defined in the rear wall.

3. The vending machine of claim 2, wherein the cover further comprises a supporting tray, and the supporting tray is secured to the cover for closing the cover and supports the plurality of fins.

4. The vending machine of claim 2, wherein an acute angle is defined between a first plane defined by the front wall and a second plane defined by the rear wall, the rear wall is substantially perpendicular to the top wall, and an obtuse angle is defined between the top wall and the front wall.

5. The vending machine of claim 2, wherein the plurality of fins has an airflow guiding passage, and the airflow guiding passage is communication with the air vent.

6. The vending machine of claim 1, wherein the temperature control system comprises a compressor, a condenser, and a bracket; the compressor and the condenser are secured to the bracket; and the compressor connects the condenser and the evaporator.

7. The vending machine of claim 6, wherein the rack defines a sliding rail, a sliding post is located on the bracket, and the sliding post is slidably secured to the sliding rail.

8. The vending machine of claim 6, wherein the bracket comprises a base, two support plates secured to the base, and a pulling plate secured to the two support plates; the temperature control system further comprises a dividing member; the compressor and the condenser are secured to the base; and a first end of the dividing member is secured to one of the two support plates, a second end of the dividing member is secured to the condenser; and the evaporator is secured to the pulling plate and the two support plates and is above the dividing member.

9. The vending machine of claim 8, wherein the dividing member comprises a dividing plate and an installation plate extending from the dividing plate; the dividing plate is secured to the two supports; the installation plate is secured to the condenser; and the dividing plate is located between the evaporator and the compressor.

10. The vending machine of claim 1, wherein the rack further comprises a bottom plate, two side plates, and a securing plate; the bottom plate is perpendicularly connected to the two side plates and the rear plate,; the securing plate extends from the rear plate; the bottom plate, the two side plates, the securing plate, and the rear plate cooperatively defines a receiving space; and the temperature control system is received in the receiving space.

11. A vending machine comprising:
a rack, the rack comprising a rear plate; and
a temperature control system, secured to the rack, comprising an evaporator, the evaporator comprising an installation box, a plurality of fins, and a fan; the plurality of fins is secured to the installation box, and the installation box comprising a cover, the cover comprising a front wall, a rear wall, and a top wall connecting the front wall to the rear wall; the plurality of fins is located on a side of the front wall; an acute angle is defined between a first plane with the front wall and a second plane with the rear wall, and an acute angle is defined between an air outlet of fan and the rear plate.

12. The vending machine of claim 11, wherein the installation box further comprises a supporting tray secured to the cover, for closing the cover.

13. The vending machine of claim 11, wherein the rear wall defines an air vent, the fan guides airflow to the rack through the air outlet, and the plurality of fins guides airflow to the rack through the air vent.

14. The vending machine of claim 13, wherein the plurality of fins has an airflow guiding passage, the airflow guiding passage is communication with the air vent.

15. The vending machine of claim 11, wherein the temperature control system comprises a compressor, a condenser, and a bracket, the compressor and the condenser are secured to the bracket, and the compressor connects the condenser and the evaporator.

16. The vending machine of claim 15, wherein the rack defines a sliding rail, a sliding post is located on the bracket, and the sliding post is slidably secured to the sliding rail.

17. The vending machine of claim 15, wherein the bracket comprises a base, two support plates secured to the base, and a pulling plate secured to the two support plates; the temperature control system further comprises a dividing member, the compressor and the condenser are secured to the base; a first end of the dividing member is secured to one of the two support plates, a second end of the dividing member is secured to the condenser; and the evaporator is secured to the pulling plate and the two support plates and is above the dividing member.

18. The vending machine of claim 17, wherein the dividing member comprises a dividing plate and an installation plate extending from the dividing plate; the dividing plate is secured to the two supports; the installation plate is secured to the condenser; and the dividing plate is located between the evaporator and the compressor.

19. The vending machine of claim 11, wherein the rack further comprises a bottom plate, two side plates, and a securing plate, the bottom plate is perpendicularly connected to the two side plates and the rear plate, the securing plate extends from the rear plate, and the bottom plate, the two side plates, the securing plate, and the rear plate cooperatively defines a receiving space, and the temperature control system is received in the receiving space.
